(19) United States
(12) Patent Application Publication
(10) Pub. No.: US 2015/0069870 A1
(43) Pub. Date: Mar. 12, 2015

(54) FLYWHEEL MAGNETIC CONTROLLER

(71) Applicant: Hsien-Mo LIN, Taichung City (TW)

(72) Inventor: Hsien-Mo LIN, Taichung City (TW)

(73) Assignee: Her Yuan Chyun Co., Ltd., Taichung City (TW)

(21) Appl. No.: 14/019,744

(22) Filed: Sep. 6, 2013

(51) Int. Cl. H02K 7/104

(52) U.S. Cl. CPC H02K 7/104
USPC 310/93

(57) ABSTRACT

A flywheel magnetic controller for mating with an existing flywheel has a magnetic wheel, an external driving module, an elongated pulling element and a rotary engaged adjustment unit. The cable assembly adjustment structure of the flywheel magnetic controller is simplified structurally, thus greatly reducing the fabrication and assembly cost, and facilitating flexible and universal assembly with better applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO A APPENDIX SUBMITTED ON COMPACT DISC

Not applicable.

### BACKGROUND OF THE INVENTION

1. Field of the Invention

The present invention relates generally to a flywheel magnetic controller, and more particularly to an innovative one which enables its operation with the cable assembly adjustment structure by rotating the engaged adjustment unit.

2. Description of Related Art Including Information Disclosed Under 37 CFR 1.97 and 37 CFR 1.98

A flywheel magnetic controller is an adjustable damper device applied to fitness equipment. A flywheel magnetic controller is generally categorized into built-in and outboard driving types, of which the present invention is intended for improvement of its outboard driving pattern.

According to said outboard driving pattern, the driving module of the magnetic adjustment structure for the flywheel magnetic controller is set externally at a spacing with the flywheel magnetic controller, and both of them are linked by a cable assembly. After assembly of said cable assembly, an adjustment means and mechanism shall be required to meet the preset drive accuracy. As for a common structure, a rotatable nut is generally set onto the cable assembly to regulate the correlation between the steel cable and conduit for the desired tightness of the steel cable. However, the following shortcomings are observed during actual applications:

Due to screwing adjustment of said rotatable nut, such unstable fixation state likely causes reverse screwing under the pulling force of the steel cable, resulting in loss of accuracy. For this problem, a positioning nut must be set additionally at one end of the rotatable nut to mate with each other for secure positioning, leading to cost increase of components. Moreover, the rotatable nut is often adjusted using a spanner, bringing about inconvenience in use. On the other hand, such adjustment structure with rotatable nut is only applied to the cable assembly composed of steel cable and conduit, so there is an urgent need to resolve such an obvious shortcoming.

Thus, to overcome the aforementioned problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the innovative structure and technical features of the present invention wherein the “flywheel magnetic controller” mainly comprises the magnetic wheel, external driving module, elongated pulling element and rotary engaged adjustment unit, the cable assembly adjustment structure of the flywheel magnetic controller hereto could be simplified structurally, thus reducing greatly the fabrication and assembly cost, and facilitating flexible and universal assembly with better applicability.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an exploded perspective view of main components of the flywheel magnetic controller in the preferred embodiment of the present invention.

FIG. 2 is a partially enlarged view of the present invention.

FIG. 3 is an exploded perspective view of the rotary engaged adjustment unit in the preferred embodiment of the present invention.

FIG. 4 is an exploded sectional view of the rotary engaged adjustment unit in the preferred embodiment of the present invention.

FIG. 5 is an assembled sectional view of the rotary engaged adjustment unit in the preferred embodiment of the present invention.

FIG. 6 is a B-B sectional view of FIG. 5.

FIG. 7 is an adjustment status view of the present invention.

FIG. 8 is an exploded perspective view of the rotary engaged adjustment unit in another preferred embodiment of the present invention.

FIG. 9 is an assembled sectional view of the rotary engaged adjustment unit in another preferred embodiment of the present invention.

FIG. 10 is an actuating sectional view of the rotary engaged adjustment unit in another preferred embodiment of the present invention.

FIG. 11 is an application view of the present invention wherein the elongated pulling element is formed by fabric tape.

FIG. 12 is an application view of the present invention wherein the driven wheel is fitted with the steel rope mating hole and fabric tape mating hole.

### DETAILED DESCRIPTION OF THE INVENTION

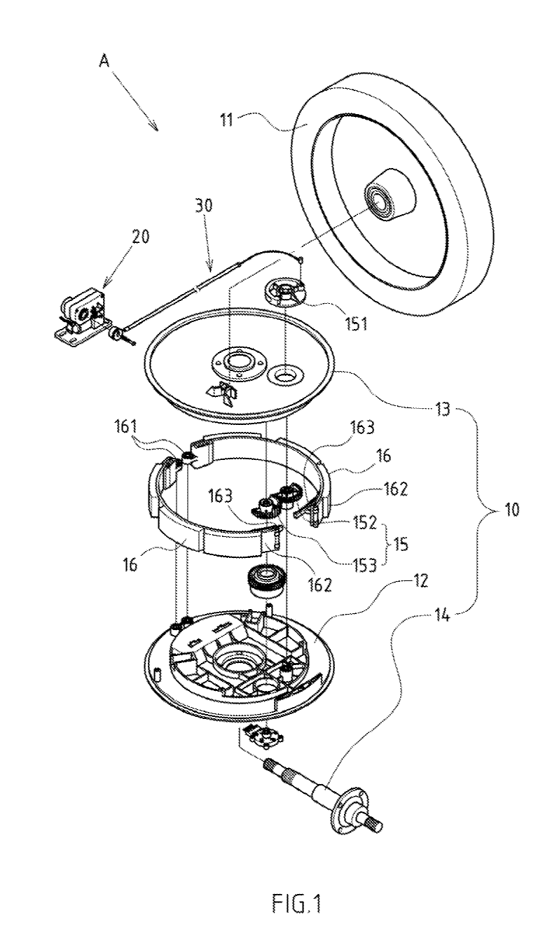

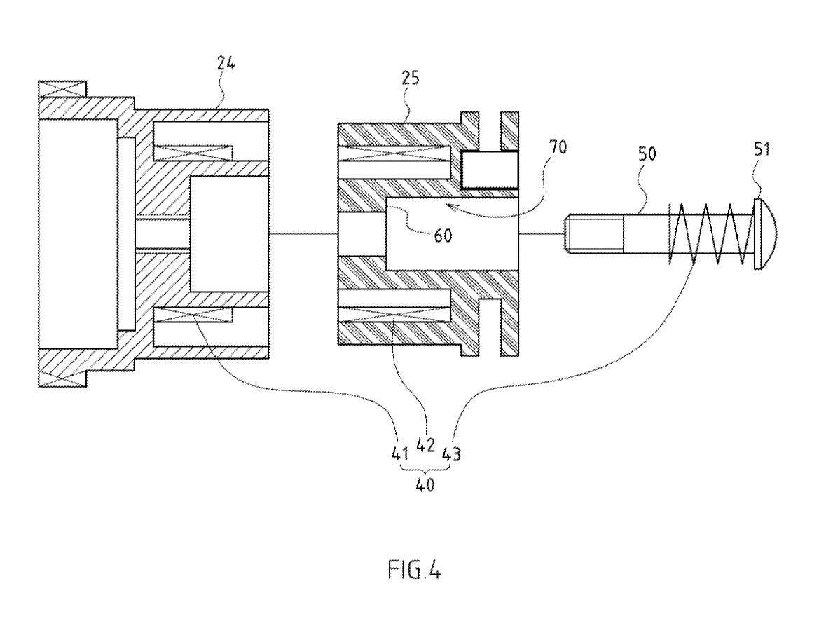

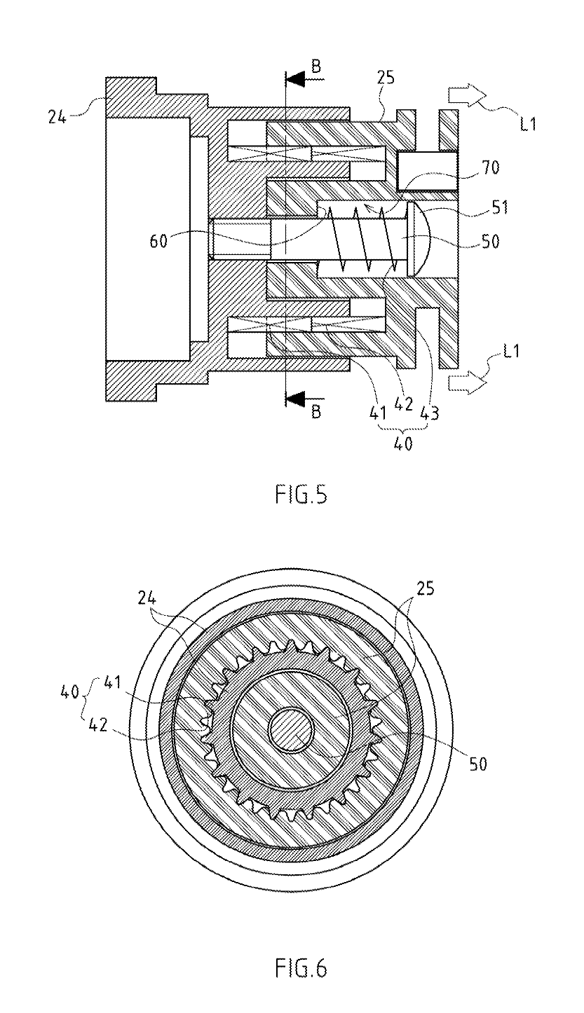

FIGS. 1-6 depict preferred embodiments of the flywheel magnetic controller of the present invention, which, however, are provided for only explanatory objective. Said flywheel magnetic controller A is mated with an existing flywheel 11.

Said flywheel magnetic controller A comprises a magnetic wheel 10, comprising of a seat body 12, a cover body 13, a central shaft 14, a drive unit 15 and two magnetic adjustment discs 16. Of which, these two magnetic adjustment discs 16 are assembled onto the seat body 11 via a pivotal portion 161, such that the moveable end 162 of these two magnetic adjustment discs 16 can swing. Said drive unit 15 comprises of a driven wheel 151 set externally on the cover body 13 and at least a driving wheel 152, 153 set into the cover body 13. With this drive unit 15, the moveable end 162 of these two magnetic adjustment discs 16 is driven to swing synchronously. Of which, the driven wheel 151 and driving wheel 152 (or 153) are linked coaxially.

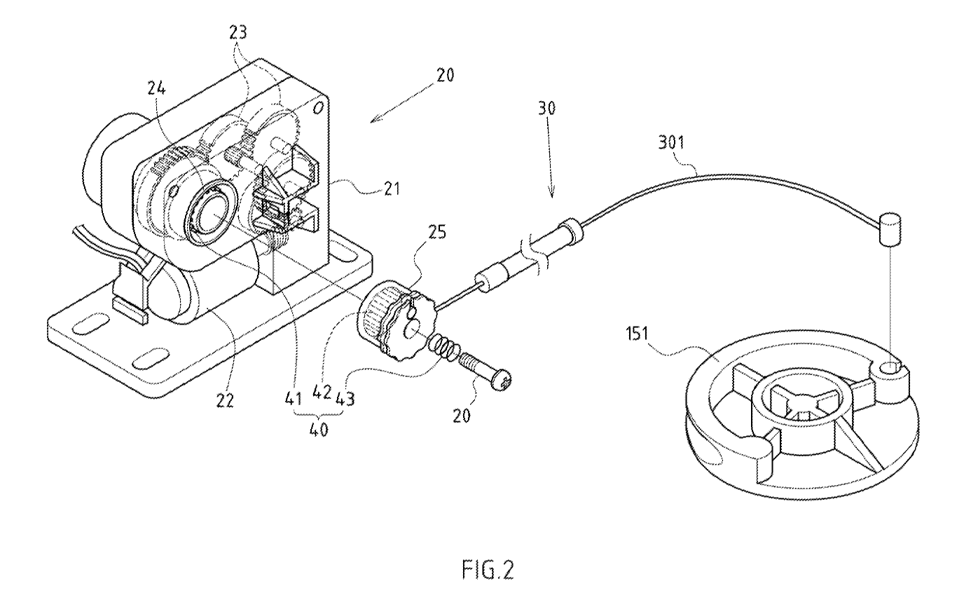

An external driving module 20 is set at a spacing with the magnetic wheel 10. Referring to FIG. 2, it comprises of a casing 21, a driving motor 22 accommodated into the casing 21, a change gear set 23 driven by the driving motor 22, a power output wheel 24 driven by the change gear set 23 and a driving end 25 protruding out of the casing 21 and driven by the power output wheel 24. The driving end 25 is bolted onto the power output wheel 24 via a bolt 50.

An elongated pulling element 30 is connected between the driving end 25 of the external driving module 20 and the driven wheel 151 of the drive unit 15 set for the magnetic wheel 10.

A rotary engaged adjustment unit 40 is set between the power output wheel 24 and driving end 25 of external driving module 20 (shown in FIGS. 2-5). Said rotary engaged adjustment unit 40 comprises of a permanent geared portion 41 and a rotatable geared portion 42 that can be engaged or disengaged from each other, as well as a restoring spring 43 (a helical spring) enabling the permanent geared portion 41 and rotatable geared portion 42 to be restored automatically into an engaged state. Of which, the permanent geared portion 41 is set into the power output wheel 24, and the rotatable geared portion 42 is set into the driving end 25.

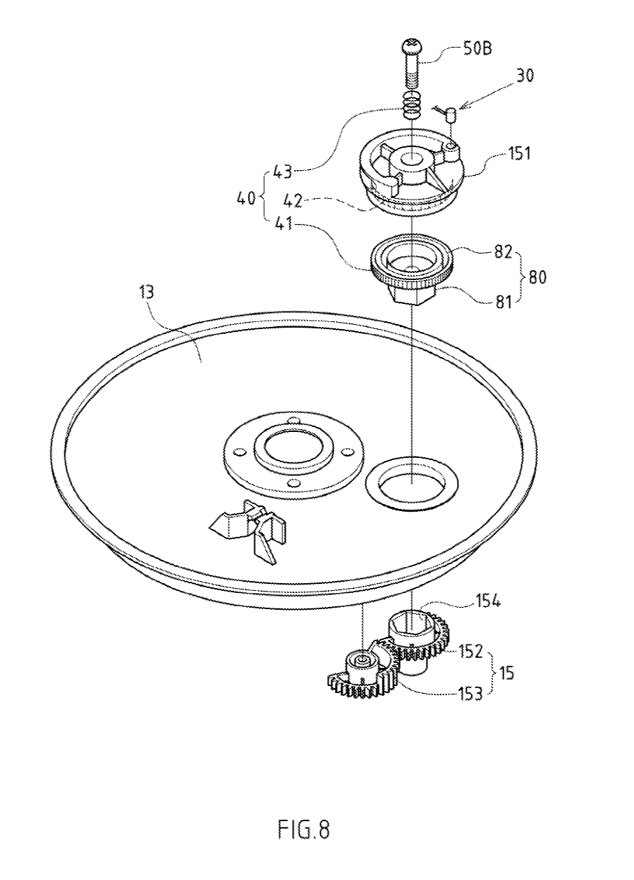

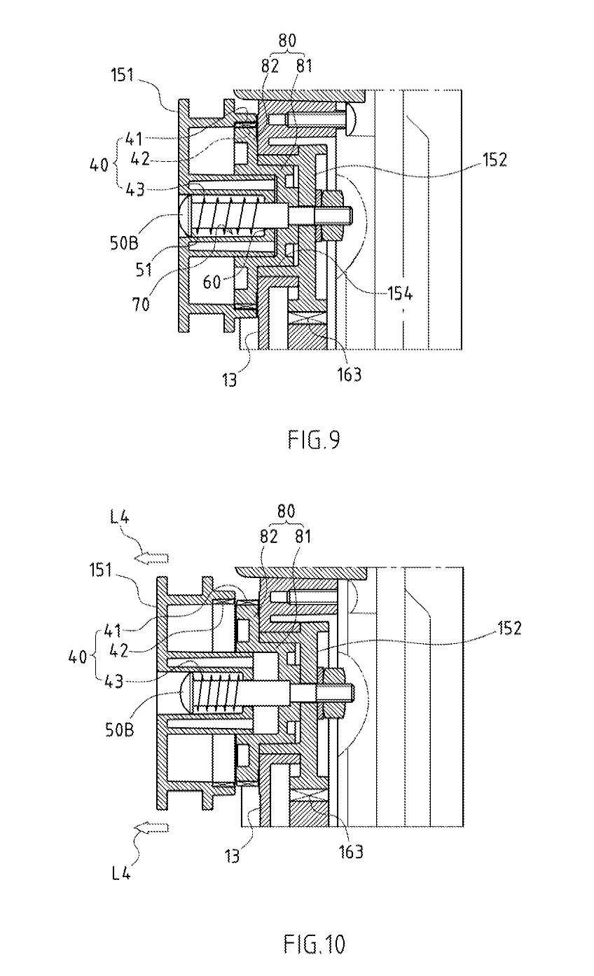

Referring also to FIGS. 8-10, a schematic view of another preferred embodiment of the rotary engaged adjustment unit 40, the driven wheel 151 and driving wheel 152 (or 153) are mated via a mating wheel 80. Said mating wheel 80 comprises of an oriented plug-in portion 81 and an expanded disk 82. Of which, the oriented plug-in portion 81 (of a hexagonal column shape) is inserted into an insertion hole 154 (of a hexagonal column shape) preset onto the driving wheel 152 or 153); said expanded disk 82 is exposed out of the cover body 13 to be mated with the driven wheel 151. The rotary engaged adjustment unit 40 is set between the driving wheel 152 (or 153) and driven wheel 151 for the drive unit 15 of the magnetic wheel 10. In this preferred embodiment, the driven wheel 151 and driving wheel 152 (or 153) is bolted and linked coaxially via a bolt 50B.

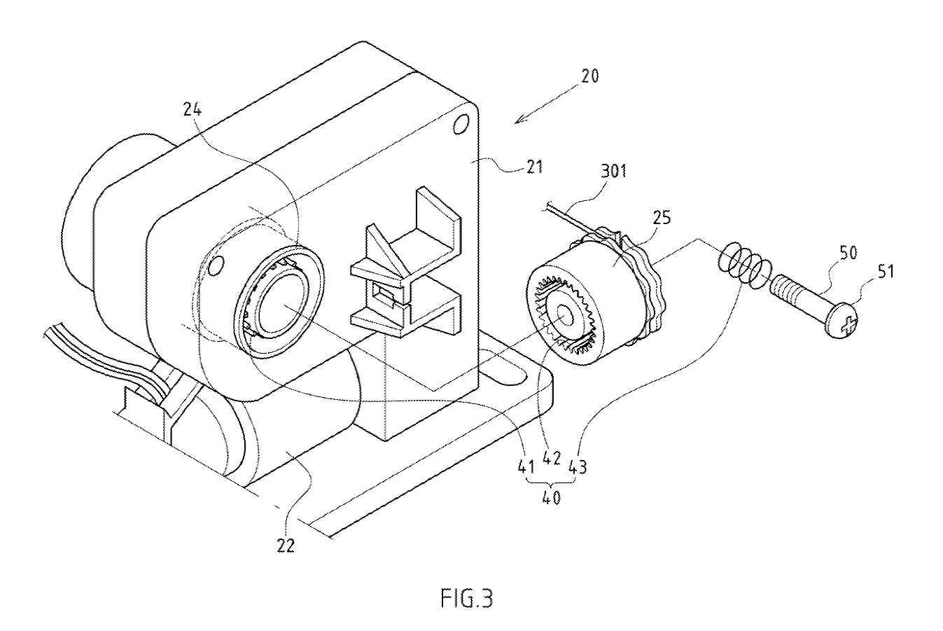

Referring to FIGS. 3-5, the driving end 25 is fitted with a circular shoulder 60. A holding space 70 is formed between the circular shoulder 60 and the head 51 of the bolt 50, so that the restoring spring 43 is assembled into the holding space 70. Moreover, the structural features of the circular shoulder 60 and holding space 70 also apply to the preferred embodiments disclosed in FIGS. 8-10, namely, the driven wheel 151 is fitted with a circular shoulder 60. Also, a holding space 70 is formed between the circular shoulder 60 and the head 51 of the bolt 50B, so that the restoring spring 43 is assembled into the holding space 70.

Referring to FIG. 2, the elongated pulling element 30 is formed by a steel rope 301.

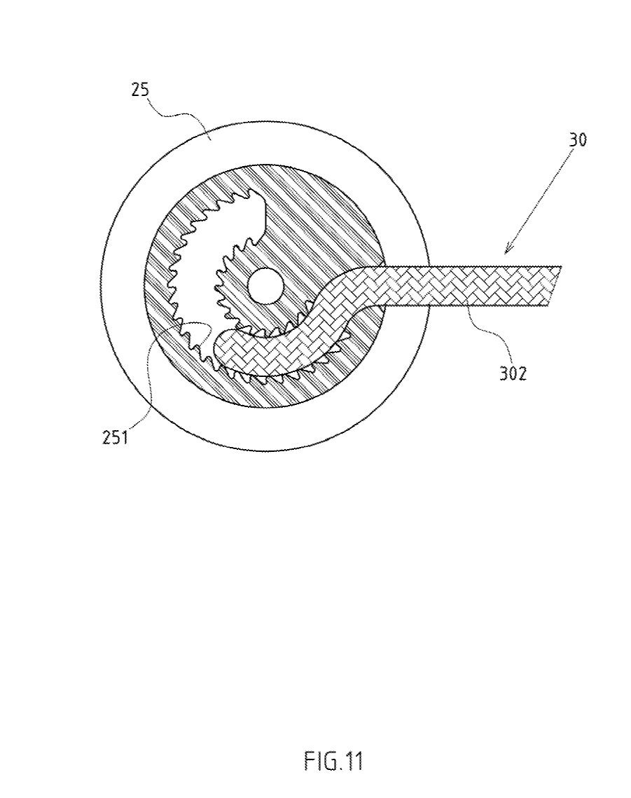

Referring to FIG. 11, the elongated pulling element is also formed by a fabric tape 302. The driving end 25 is fitted with an arched ratchet positioning groove 251 for insertion and positioning of the end of the fabric tape 302 (note: adhesive can be used for further fixation).

Referring to FIG. 1, the driving wheels 152, 153 of said drive unit 15 can be engaged in the form of left and right wheels, so that gear rows 163 are set at the moveable ends 162 of two magnetic adjustment discs 16 for meshing with the gear rim of the driving wheels 152, 153. In such case, the driving wheels 152, 153 can synchronously drive the moveable ends 162 of two magnetic adjustment discs 16 for swinging motion. When said gear rows 163 are actuating, they move in a circumferential path according to the oscillation of two magnetic adjustment discs 16.

Of which, the permanent geared portion 41 and rotatable geared portion 42 of the rotary engaged adjustment unit 40 are coaxially configured inwards or outwards.

Based on the above-specified structural design, the core design of the present invention lies in the innovative structure of rotary engaged adjustment unit 40 that can be set between the power output wheel 24 and driving end 25 of the external driving module 20 (shown in FIGS. 2-5), or between the mating wheel 80 and driven wheel 151 of the drive unit 15 (shown in FIGS. 8-10). As for the preferred embodiment disclosed in FIGS. 1-6, when the user intends to adjust the tightness of the elongated pulling element 30, as shown in FIG. 5, the driving end 25 is pulled outwards (indicated by arrow L1) until the permanent geared portion 41 and rotatable geared portion 42 of the rotary engaged adjustment unit 40 are fully disengaged, making the driving end 25 in a release state. Meanwhile, the restoring spring 43 is pressed to accumulate its elastic force.

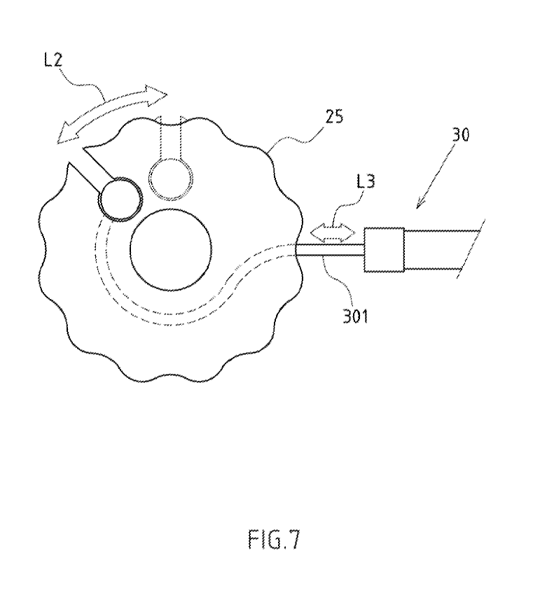

Referring also to FIG. 7, the user could rotate clockwise or counterclockwise the driving end 25 (indicated by arrow L2), so as to adjust the tightness of the steel rope 301 of the elongated pulling element 30 (indicated by arrow L3). As compared with prior art, the permanent geared portion 41 and rotatable geared portion 42 of the rotary engaged adjustment unit 40 of the present invention could be directly formed on the flywheel magnetic controller components such as the power output wheel 24, driving end 25 or the mating wheel 80 and driven wheel 151 of the drive unit 15, so very few components are required (note: only the restoring spring 43 is additionally fabricated), reducing greatly the fabrication and assembly cost. On the other hand, as the rotary engaged adjustment unit 40 of the present invention is not assembled onto the steel rope, the elongated pulling element made of either steel rope or fabric tape can apply to flexible and universal assembly. Furthermore, the rotary engaged adjustment unit 40 of the present invention features ease-of-operation, since the user is only required to pull manually the driving end 25 or driven wheel 151 for adjustment without other tools.

Referring to FIGS. 8-10, when the user intends to adjust the tightness of the elongated pulling element 30, the driven wheel 151 is pulled outwards for rotation (indicated by arrow L4 in FIG. 10), such that the permanent geared portion 41 and rotatable geared portion 42 of the rotary engaged adjustment unit 40 can be disengaged into a release state.

Referring to FIG. 2, the elongated pulling element 30 is formed by a steel rope 301.

Referring to FIG. 11, the elongated pulling element is formed by a fabric tape 302.

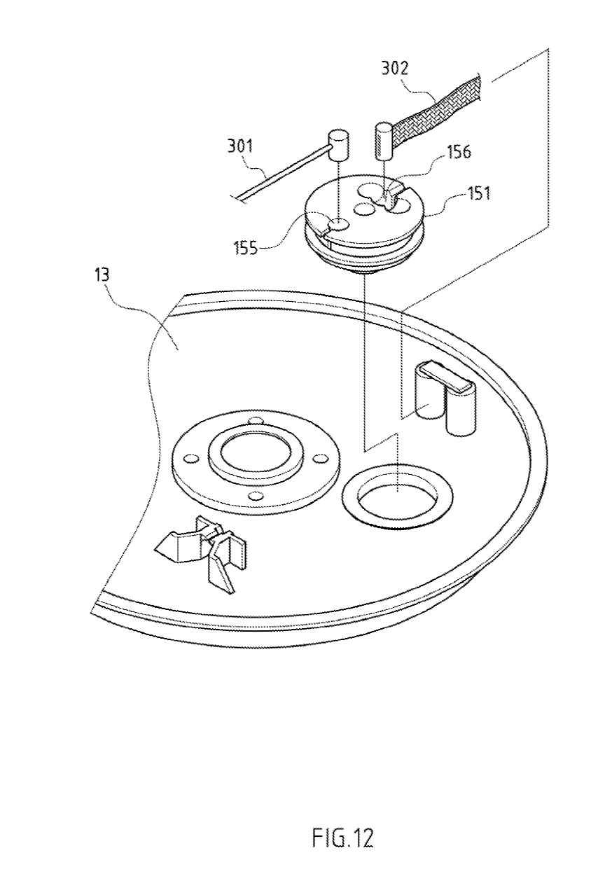

Referring also to FIG. 12, the driven wheel 151 is structurally designed in such a way that a steel rope mating hole 155 and a fabric tape mating hole 156 are set separately at both sides. Alternatively, steel rope 301 or fabric tape 302 can be assembled depending on different elongated pulling elements, but different types of driven wheels 151 must be fabricated to cut down the fabrication cost.

1. A flywheel magnetic controller, which is mated with an existing flywheel said flywheel magnetic controller comprising:
a magnetic wheel, comprising of a seat body, a cover body, a central shaft, a drive unit and two magnetic adjustment discs; of which these two magnetic adjustment discs are assembled onto the seat body via a pivotal portion, such that the moveable end of these two magnetic adjustment discs can swing; said drive unit comprises of a driven wheel set externally on the cover body and at least a driving wheel set into the cover body; with this drive unit, the moveable end of these two magnetic adjustment discs is driven to swing synchronously; of which the driven wheel and driving wheel are linked coaxially;
an external driving module, set at a spacing with the magnetic wheel; it comprises of a casing, a driving motor accommodated into the casing, a change gear set driven by the driving motor, a power output wheel, driven by the change gear set and a driving end protruding out of the casing and driven by the power output wheel; and the driving end is bolted onto the power output wheel via a bolt;
an elongated, pulling element, connected between the driving end of the external driving module and the driven wheel of the drive unit set for the magnetic wheel;
a rotary engaged adjustment unit set between the power output wheel and driving end of external driving module; said rotary engaged adjustment unit comprises of a permanent geared portion and a rotatable geared portion that can be engaged or disengaged from each other, as well as a restoring spring enabling the permanent geared portion and rotatable geared portion to be restored automatically into an engaged state; of which the permanent geared portion is set into the power output wheel, and the rotatable geared portion is set into the driving end;
the rotatable geared portion in release state could rotate clockwise or counterclockwise so as to adjust the tightness of the elongated pulling element.

2. The device defined in claim 1, wherein a holding space is formed between the circular shoulder of the driving end and the head of the bolt, so that the restoring spring is assembled into the holding space.

3. The device defined in claim 2, wherein said elongated pulling element is formed b a steel rope.

4. The device defined in claim 2 wherein said elongated pulling element is formed by a fabric tape; the driving end is fitted with an arched ratchet positioning groove for insertion and positioning of the end of the fabric tape.

5. The device defined in claim 3, wherein the driving wheels of said drive unit can be engaged in the form of left and right wheels, so that gear rows are set at the moveable ends of two magnetic adjustment discs for meshing with the gear rim of the driving wheels; in such case, the driving wheels can synchronously drive the moveable ends of two magnetic adjustment discs for swinging motion, when said gear rows are actuating, they move in a circumferential path according to the oscillation of two magnetic adjustment discs.

6. The device defined in claim 5, wherein the permanent geared portion and rotatable geared portion of the rotary engaged adjustment unit are coaxially configured inwards or outwards.

7. A flywheel magnetic controller, which is mated with an existing flywheel, said flywheel magnetic controller comprising:
a magnetic wheel, comprising of a seat body, a cover body, a central shaft, a drive unit and two magnetic adjustment discs; of which these two magnetic adjustment discs are assembled onto the seat body via a pivotal portion, such that the moveable end of these two magnetic adjustment discs can swing; said drive unit comprises of a driven wheel set externally on the cover body and at least a driving wheel set into the cover body; with this drive unit, the moveable end of these two magnetic adjustment discs is driven to swing synchronously; of which the driven wheel and driving wheel are linked coaxially via a bolt; the driven wheel and driving wheel are mated via a mating wheel; said mating wheel comprises of an oriented plug-in portion and an expanded disk; of which the oriented portion is inserted into an insertion hole preset onto the driving wheel; said expanded disk is exposed out of the cover body to be mated with the driven wheel;
an external driving module, set at a spacing with the magnetic wheel; it comprises of a casing, a driving motor accommodated into the casing, a change gear set driven by the driving motor, a power output wheel driven by the change gear set and a driving end protruding out of the casing and driven by the power output wheel;
an elongated pulling element, connected between the driving end of the external driving module and the driven wheel of the drive unit set for the magnetic wheel;
a rotary engaged adjustment unit, set between the mating wheel and driven wheel for the drive unit of the magnetic wheel; said rotary engaged adjustment unit comprises of a permanent geared portion and a rotatable geared portion that can be engaged or disengaged from each other, as well as a restoring spring enabling the permanent geared portion and rotatable geared portion to be restored automatically into an engaged state; of which the permanent geared portion is set into the expanded disk of the mating wheel, and the rotatable geared portion is set into the driven wheel;
the rotatable geared portion in release state could rotate clockwise or counterclockwise so as to adjust the tightness of the elongated pulling element.

8. The device defined in claim 7, wherein a holding space is formed between the circular shoulder of the driving end and the head of the bolt, so that the restoring spring is assembled into the holding space.

9. The device defined in claim 8, wherein said elongated pulling element is formed by a steel rope.

10. The device defined in claim 8, wherein said elongated pulling element is formed by a fabric tape; the driving end is fitted with an arched ratchet positioning groove for insertion and positioning of the end of the fabric tape.

11. The device defined in claim 9, wherein the driving wheels of said drive unit can be engaged in the form of left and right wheels, so that gear rows are set at the moveable ends of two magnetic adjustment discs for meshing with the gear rim of the driving wheels; in such case, the driving wheels can synchronously drive the moveable ends of two magnetic adjustment discs for swinging motion; when said gear rows are actuating, they move in a circumferential path according to the oscillation of two magnetic adjustment discs.

12. The device defined in claim 11, wherein the permanent geared portion and rotatable geared portion of the rotary engaged adjustment unit are coaxially configured inwards or outwards.
